(19) United States
(12) Patent Application Publication
(10) Pub. No.: US 2013/0099729 A1
(43) Pub. Date: Apr. 25, 2013

(54) COIL STRUCTURE FOR WIRELESS CHARGING AND WIRELESS CHARGING APPARATUS HAVING THE SAME

(71) Applicants: Jung Ho YOON, Gyunggi-do (KR); Young Seok YOON, Chungcheongnam-do (KR); Kwang Du LEE, Gyunggi-do (KR); Hyun Seok LEE, Seoul (KR); Eung Ju KIM, Gyunggi-do (KR); Sam Ki JUNG, Gyunggi-do (KR)

(72) Inventors: Jung Ho YOON, Gyunggi-do (KR); Young Seok YOON, Chungcheongnam-do (KR); Kwang Du LEE, Gyunggi-do (KR); Hyun Seok LEE, Seoul (KR); Eung Ju KIM, Gyunggi-do (KR); Sam Ki JUNG, Gyunggi-do (KR)

(73) Assignee: SAMSUNG ELECTRO-MECHANICS CO., LTD., Gyunggi-do (KR)

(21) Appl. No.: 13/352,030

(22) Filed: Jan. 17, 2012

(30) Foreign Application Priority Data
Oct. 25, 2011 (KR) 1020110109543

(51) Int. Cl. H02J 17/00; H01F 27/28; H02J 7/00

(52) U.S. Cl. 320/108; 336/232

(57) ABSTRACT

The wireless charging apparatus according to the preferred embodiment of the present invention includes a control unit performing a general control of a wireless charging process; a driving unit connected to the control unit to generate a wireless power signal to be transmitted according to the control of the control unit; a transmission coil unit connected to the driving unit as a coil structure in a dumbbel form and transmitting wireless power according to the wireless power signal, the turn loop having a major-axis side of which one side is longer than the other side and at least one area is formed in a form depressed inwardly; and a sensing unit connected between the transmission coil unit and the control unit to detect whether the wireless charging receiver is positioned corresponding to the transmission coil unit and transfer the detected state to the control unit.

### CROSS REFERENCE TO RELATED APPLICATION

This application claims the benefit of Korean Patent Application No. 10-2011-0109543, filed on Oct. 25, 2011, entitled “Coil Structure For Wireless Chargement And Wireless Charging Apparatus Having The Same”, which is hereby incorporated by reference in its entirety into this application.

### BACKGROUND OF THE INVENTION

1. Technical Field

The present invention relates to a coil structure for wireless charging and a wireless charging apparatus having the same.

2. Description of the Related Art

A wireless charging technology is a technology of transmitting power required to wirelessly charge a battery without a power cord or a charging connector. The wireless charging technology of the prior art has been used for a limited purpose such as an electric tooth brush or a household wireless telephone, an electric tool, or the like.

However, with the recently explosive increase of a smart phone market, the expansion of the wireless charging technology has been accelerated. The smart phone can allow a user to freely use various contents and multimedia anytime. On the other hand, there is a problem in that a usage time is short due to the limited capacity of the battery. The situation of the wireless charging technology in the smart phone market has been greatly changed as a result of an appearance of a wireless charging responding smart phone from 2010. Products in which a wireless charging module is mounted have been continuously published at home and abroad so as to wirelessly charge a mobile phone and a smart phone in 2011.

The wireless power consortium (WPC) aiming at expanding a non-contact type standard has first published standard specifications for devices outputting 5 W or less in July, 2010, and as a result, businesses subscribing to the organizations have been continuously increased. The wireless charging technology which has an expanding market due to the adaptation of the smart phone is expected to be widely used for devices outputting large power such as a digital camera, a tablet PC, a monitor, a digital TV, or the like, in future.

Among several technologies capable of implementing the wireless charging, an electromagnetic induction type excellent in view of production and commercialization has been considered. The electromagnetic induction type uses electromagnetic energy coupling generated among coils wound several times as described in Korean Patent Laid-Open Publication No. 2010-0094197 (Publication in Aug. 26, 2010).

This is based on a Faraday's law that allows magnetic field generated by a coil in which AC or high frequency current flows to generate electromotive force at output terminals of adjacent coils. When a general mobile phone, a smart phone, a digital camera, a tablet PC, a monitor, a notebook, or the like, in which a wireless charging receiving module is mounted are put on a charging surface of a wireless charger in which a wireless charging transmitting module is mounted, a battery mounted in the devices is charged by an operation of an analog circuit, a power circuit, a control circuit, a rectifier, a charging circuit, or the like, that are responsible for charging.

In the configuration, a shape, a number, an arrangement, or the like, of the transmission coil disposed immediately under the wireless charger are main variables determining a distribution of charging efficiency on the charging surface.

In addition, when a plurality of coils is arranged in one direction, a freedom-of-position in one direction is given to a user, thereby enhancing the user convenience. The wireless charger according to the related art has mainly used a coil structure having a narrow area but has used small coils arranged so as to obtain satisfactory charging efficiency in a wide area.

However, the above-mentioned type complicates the configuration since there is a need to switch between the coils and driving circuits and amplifiers corresponding to the number of coils are needed.

### SUMMARY OF THE INVENTION

The present invention has been made in an effort to provide a coil structure having a dumbbell shape capable of improving wireless charging efficiency using a single coil.

In addition, the present invention has been made in an effort to provide a wireless charging apparatus including a coil structure having a dumbbell shape capable of improving wireless charging apparatus including a single structure.

According to a preferred embodiment of the present invention, there is provided a coil structure for wireless charging, including: a turn loop formed of a single coil, the turn loop having a major-axis side of which one side is longer than the other side, and wherein at least one area of the major-axis side is formed in a form depressed inwardly.

The coil structure for wireless charging may form a flat loop in a dumbbell form in which a depressed area d of the middle portion thereof is depressed inwardly by a step e.

The depressed area d may be depressed inwardly by the step e in an arc form or an angled form.

According to another preferred embodiment of the present invention, there is provided a wireless charging apparatus, including: a control unit performing a general control of a wireless charging process; a driving unit connected to the control unit to generate a wireless power signal to be transmitted according to the control of the control unit; a transmission coil unit connected to the driving unit as a coil structure in a turn loop form formed of a single coil and transmitting wireless power according to the wireless power signal, the turn loop form having a major-axis side of which one side is longer than the other side and at least one area is formed in a form depressed inwardly; and a sensing unit connected between the transmission coil unit and the control unit to detect whether the wireless charging receiver is positioned corresponding to the transmission coil unit and transfer the detected state to the control unit.

The driving unit may include a single driving circuit and amplifier for the transmission coil unit.

The coil structure of the transmission coil unit may form a loop in a dumbbell shape in which a middle area of the major-axis side is depressed inwardly.

As a coupling coefficient K regarding the transmission coil unit is large, a value of inductance L of the transmission coil unit required to transmit the wireless power may be small and as the inductance L is small, the number of turn loops of the transmission coil unit may be small.

### BRIEF DESCRIPTION OF THE DRAWINGS

FIG. 1 is a block diagram of a wireless charging apparatus according to a preferred embodiment of the present invention.

FIG. 2 is a top view showing a transmission coil unit according to a preferred embodiment of the present invention.

FIG. 3 is a top view showing a transmission coil unit according to another preferred embodiment of the present invention.

FIG. 4 is a top view showing a transmission coil unit according to another preferred embodiment of the present invention.

FIG. 5 is an exemplified diagram for describing a function of the wireless charging apparatus according to the preferred embodiment of the present invention.

FIG. 6 is a graph for describing inductance and wireless power transmission efficiency according to coupling coefficient and input and output impedance according to the preferred embodiment of the present invention.

FIG. 7 is a graph for describing wireless power transmission efficiency according to coupling coefficient and parasitic resistance of the coil unit according to the preferred embodiment of the present invention.

FIG. 8 is a graph showing a distribution of the coupling coefficient according to a position of a receiving device from a center of the coil unit according to the preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. The terms are used only to distinguish one element from another element. In describing the present invention, a detailed description of related known functions or configurations will be omitted so as not to obscure the gist of the present invention.

Hereinafter, preferred embodiments of the present invention will be described in detail with reference to the accompanying drawings.

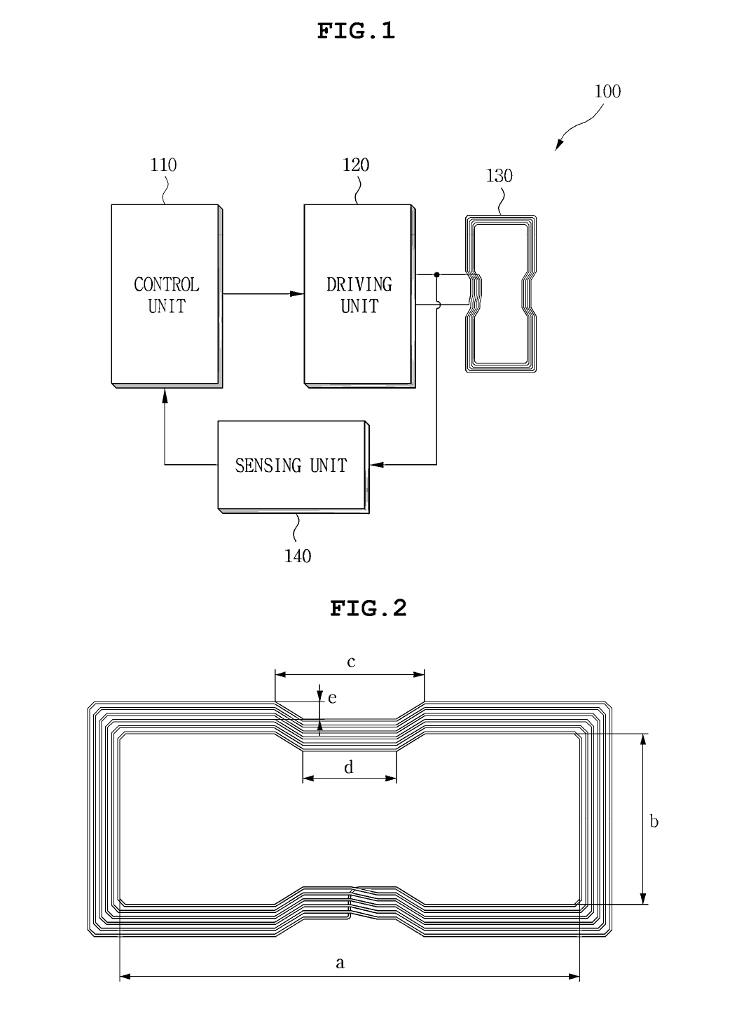

FIG. 1 is a block diagram of a wireless charging apparatus according to a preferred embodiment of the present invention.

As shown in FIG. 1, a wireless charging apparatus 100 according to a preferred embodiment of the present invention may be configured to include a control unit 110, a driving unit 120, a transmission coil unit 130, and a sensing unit 140.

The control unit 110 performs a general control of a wireless charging process and receives information on whether the wireless charging receiver (not shown) is positioned corresponding to the transmission coil unit 130 from the sensing unit 140. As a result, the control unit 110 controls the driving unit 120 to drive the transmission coil unit 130.

In detail, the control unit 110 compares current or voltage received from the sensing unit 130 with a predetermined setting value to determine that the receiver is present when the received current value is smaller than the setting value or the received voltage is larger than the setting value and to determine that the receiver is not present when the received current value is larger than the setting value or the received voltage is smaller than the setting value. In this case, the predetermined setting value may be set to be a middle value of minimum current and voltage according to a change in minimum electromagnetic field at the time of charging the receiver for predetermined wireless charging.

If it is determined that the receiver is present, the control unit 110 generates and transfers control information, for example, wake-up information controlling the driving unit 120.

The driving unit 120 includes a single driving circuit and amplifier for the transmission coil unit 130 and receives the wake-up information, thereby generating a wireless power signal to be transmitted according to the information of the transmission coil unit 130 included in the wake-up information.

The transmission coil unit 130 transmits the wireless power to the corresponding receiver according to the wireless power signal.

As shown in FIG. 2, the transmission coil unit 130 may is formed of a turn loop having major-axis sides in a single coil, the major-axis sides being configured to have a side longer than the other side, thereby obtaining a freedom-of-position in one direction with respect to a wireless charging area.

In addition, the transmission coil unit 130 may be formed to have a dumbbell shape in which at least one portion, preferably, a middle portion of each of the major-axis sides is depressed inwardly so as to compensate for a non-uniform electromagnetic field distribution generated due to a simple rectangular shape.

In this case, both ends of the transmission coil unit 130 are connected with the driving unit 120 and one terminal is branched and connected to the sensing unit 140 so as to determine whether the receiver to be wirelessly charged is present.

In detail, the transmission coil unit 130 according to the preferred embodiment of the present invention shown in FIG. 2 is formed of the turn loop in a single coil when being viewed from the top. In this case, the transmission coil unit 130 has major-axis sides a longer than minor-axis sides b. Meanwhile, depressed areas d may be depressed inwardly by a step e at middle regions c of each of the two major-axis sides a, thereby forming the flat loop in the dumbbell shape when being viewed from the top.

In this case, a portion other than the depressed area d at the middle area c, that is, a portion determining the step e may be connected in a shape having an angle and the step e may be controlled to compensate for the electromagnetic distribution according to the entire size of the transmission coil unit 130, the magnitude of the electromagnetic field to be generated, or the like.

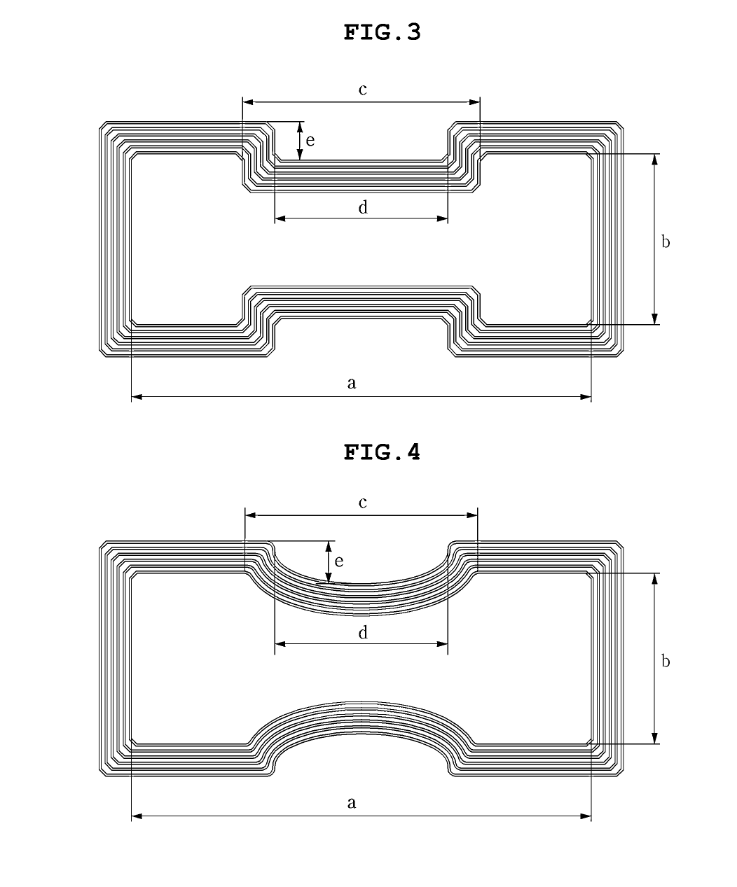

Therefore, the transmission coil unit 130 may be provided in various shapes and the depressed area d of the transmission coil unit according to another preferred embodiment of the present invention shown in FIG. 3 is connected with the middle area c at a right angle to form the step e.

Alternatively, the depressed area d of the transmission coil unit according to another preferred embodiment of the present invention shown in FIG. 4 has a round arc in an inward direction and is connected with the middle area c, thereby forming the step e.

Therefore, the wireless charging apparatus according to the preferred embodiment of the present invention includes the transmission coil unit formed of the turn loop using the single coil. By this configuration, the preferred embodiment of the present invention can solve the problems of the prior art of the complicated configuration in which the transmission coil unit is arranged by the plurality of coils and the driving circuit and the amplifier corresponding to the number of coils are provided.

In addition, the wireless charging apparatus according to the preferred embodiment of the present invention forms the transmission coil unit having various step shapes in the dumbbell shape, thereby compensating for the non-uniform electromagnetic field distribution generated due to the shape of the transmission coil unit formed in the simply rectangular turn loop.

Hereinafter, the performance of the wireless charging apparatus including the transmission coil unit formed of the turn loop in the dumbbell shape according to the preferred embodiment of the present invention will be described in more detail by the following Examples and Comparative Examples. In this case, the following preferred Examples and Comparative Examples illustrate the contents of the preferred embodiments of the present invention and the scope of the preferred embodiments of the present invention is not limited to Examples and Comparative Examples.

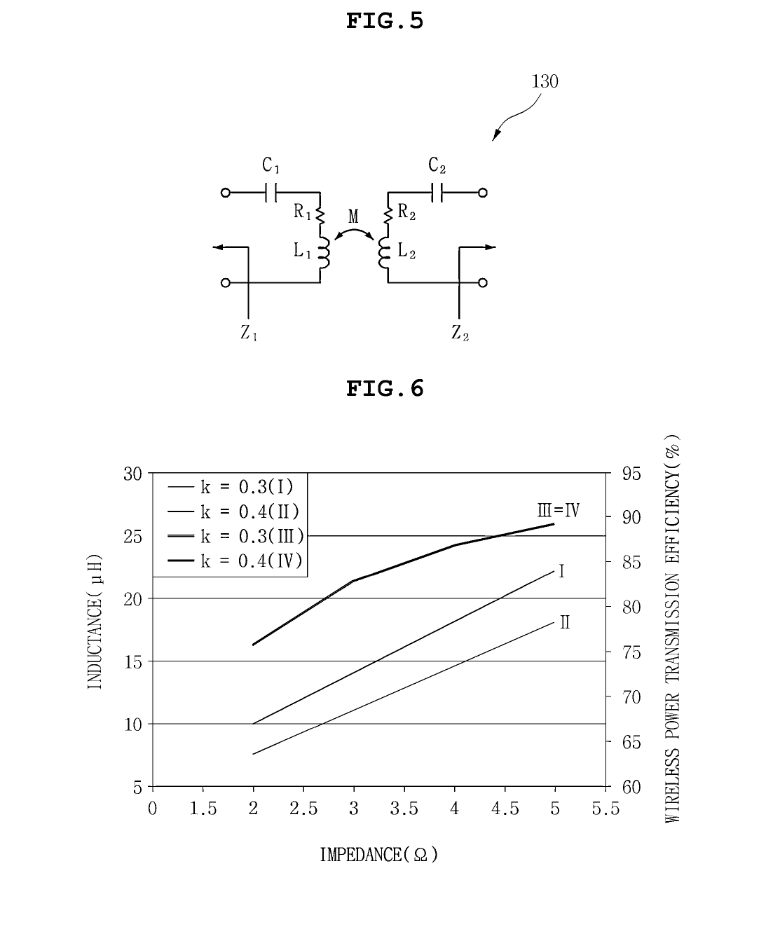

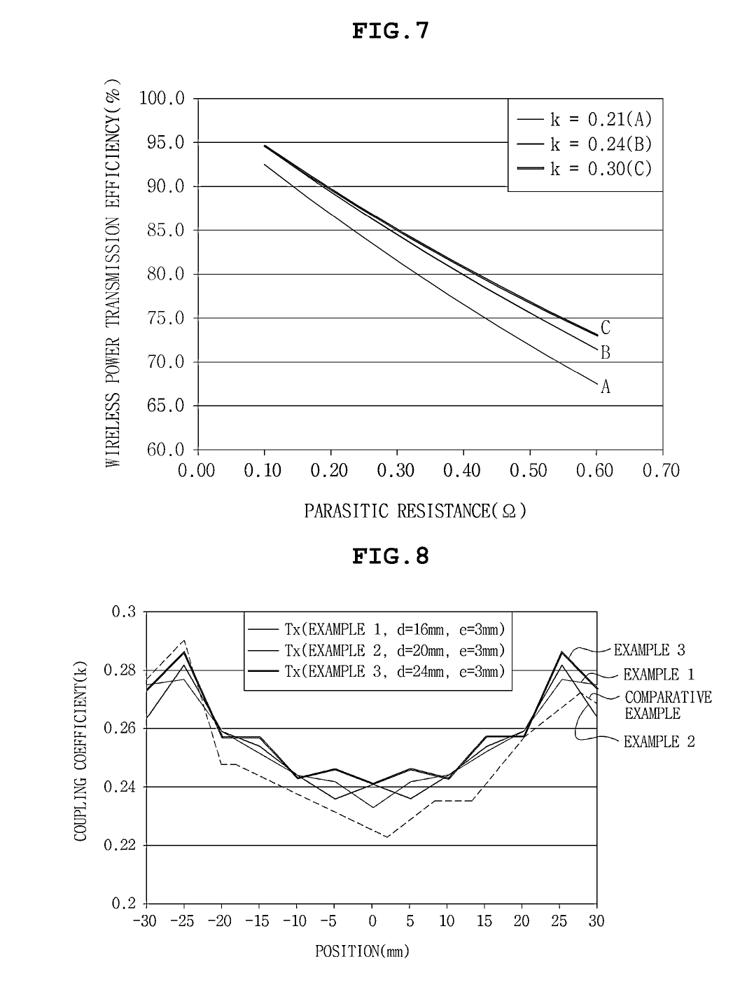

First, factors relating to the wireless power transmission efficiency of the wireless charging apparatus including the transmission coil unit 130 forming of the turn loop in the dumbbell shape will be described with reference to FIGS. 5 to 7. FIG. 5 is an exemplified diagram for describing a function of the wireless charging apparatus according to the preferred embodiment of the present invention, FIG. 6 is a graph for describing inductance and wireless power transmission efficiency according to coupling coefficient and input and output impedance in accordance with a preferred embodiment of the present invention, and FIG. 7 is a graph for describing wireless power transmission efficiency according to coupling coefficient and parasitic resistance of the coil unit in accordance with a preferred embodiment of the present invention.

As shown in FIG. 5, the transmission coil unit 130 formed of the turn loop in the dumbbell shape according to the preferred embodiment of the present invention may represent inductance L1 of the transmission coil unit, parasitic resistance R1 of the transmission coil unit, and resonant capacitance C1 of the transmission coil unit and the receiver that is an object of the wireless charging represents inductance L2 of a receiving side coil, parasitic resistance R2 of the receiving side coil, and resonant capacitance C2 of a receiving side coil. Herein, Z1 is output impedance of the wireless charging apparatus and Z2 is input impedance of a receiving side rectifier.

In the wireless charging apparatus 100 as described above, the most important factor representing the wireless power transmission efficiency is a coupling coefficient K, wherein the coupling coefficient K may be obtained from the coil of the transmission coil unit 130 and the coil of the receiver and the inductance L and the mutual inductance M of two coils as in the following Equation 1.

$$K = \frac{M}{\sqrt{{L}_{1} {L}_{2}}} \qquad [ Equation 1 ]$$

The coupling coefficient K represents an amount of wireless power physically flowing from one coil to the other coil by a constant. It means that as the value of the coupling coefficient K is larger, the flowing amount of wireless power is increased. The coupling coefficient K has a range of 0 to 1.

The factor representing the wireless power transmission efficiency other than the coupling coefficient K as described above is the inductance L of the coil as shown in FIG. 6. FIG. 6 is a graph for representing the maximum wireless power transmission efficiency according to the output impedance Z1 of the wireless charging apparatus and the input impedance Z2 of the receiving side rectifier and the value of the minimum inductance L of the coil required so as to obtain the maximum wireless power transmission efficiency.

It can be appreciated from graphs “I’ and ‘II’ regarding the inductance L in the graph that as the output impedance Z1 of the wireless charging apparatus and the input impedance Z2 of the receiving side rectifier are increased, the value of inductance L required to maximally obtain the wireless power transmission efficiency between two coils is increased.

On the other hand, it can be appreciated from graphs III and IV regarding the wireless power transmission efficiency that when two coils have the value of inductance of a predetermined value or more, the maximum wireless transmission efficiency obtained between the coils has nothing to do with the coupling coefficient K between two coils.

Therefore, in the wireless power transmission between two coils, the impedance of the input and output circuit connected to the coil may be an important factor, which means that the value of used inductance L is increased accordingly.

In addition, the value of inductance L required for the wireless power transmission is small as the coupling coefficient K is increased and the turn number of the loop coil required to form the transmission coil unit 130 may be reduced when the required inductance L is small. This also means that the size of the coil unit 130 may be small.

Therefore, when the size and the turn number of the coil forming the transmission coil unit 130 is set, the shape of the transmission coil unit 130 capable of obtaining the coupling coefficient k at a predetermined level or more.

Another factor of the wireless power transmission efficiency may include the parasitic resistance included in the coil as shown in FIG. 7.

FIG. 7 is a graph showing the wireless power transmission efficiency according to the parasitic resistance of the coil. It can be appreciated from the graph that as the parasitic resistance included in the coil is small, the wireless power transmission efficiency is increase and the parasitic resistance included in the coil is small, the change in the wireless power transmission efficiency according to the change in the coupling coefficient K is small.

In conclusion, a designer needs to design a coil shape by reducing the impedance of the input and output circuit to reduce the value of inductance L required for the transmission coil unit 130 and obtaining the coupling coefficient K at a predetermined level or more from two coils.

The coupling coefficient K between the coils used for the transceiver does not have the uniform value over the coil area and a designer is important to design the coil shape so as to make the distribution of the coupling coefficient uniform by controlling the coil shape. Generally, the coupling coefficient has a value of about 0.2 to 0.3 due to the thickness of the case of the device between the transmitting and receiving coils.

### Example 1

In the wireless charging apparatus 100 according to the present invention, the transmission coil unit 130 is formed of a single turn loop in the dumbbell shape and the major-axis side a of the transmission coil unit 130 is 80 mm and the minor-axis side b is 30 mm and the depressed area d of 16 mm forms the turn loop in the dumbbell shape depressed inwardly by the step e of 3 mm.

### Example 2

In the wireless charging apparatus 100 according to the present invention, the transmission coil unit 130 is formed of a single turn loop in the dumbbell shape and the major-axis side a of the transmission coil unit 130 is 80 mm and the minor-axis side b is 30 mm and the depressed area d of 20 mm forms the turn loop in the dumbbell shape depressed inwardly by the step e of 3 mm.

### Example 3

In the wireless charging apparatus 100 according to the present invention, the transmission coil unit 130 is formed of a single turn loop in the dumbbell shape and the major-axis side a of the transmission coil unit 130 is 80 mm and the minor-axis side b is 30 mm and the depressed area d of 24 mm forms the turn loop in the dumbbell shape depressed inwardly by the step e of 3 mm.

### Comparative Example

In the wireless charging apparatus 100 according to the present invention, the transmission coil unit is formed of a single turn loop in a rectangular form rather than the dumbbell shape and is formed of the turn loop in a form in which the major-axis a side of the transmission coil part 130 is 80 mm and the minor-axis side b is 30 mm.

The calculated coupling coefficient K calculated according to a position far away from the center of the transmission coil part 130 of each of the above-mentioned Examples and Comparative Examples may be shown as shown in FIG. 8. It can be appreciated from the graph shown in FIG. 8 that the coupling coefficient K of the central portion of the transmission coil unit of Examples and Comparative Examples is small and is increased toward the outside thereof, thereby representing the non-uniform distribution.

In detail, standard deviations of the coupling coefficient K regarding the transmitting coil unit 130 of each of Examples and Comparative Examples may be represented as Table 1.

TABLE 1

| | Example 1 | Example 2 | Example 3 | |
|---|---|---|---|---|
| | (d = 16 mm, | (d = 20 mm, | (d = 24 mm, | Comparative |
| | e = 3 mm) | e = 3 mm) | e = 3 mm) | Example |
| Standard | 0.0142 | 0.0162 | 0.0160 | 0.0176 |
| Deviation of | | | | |
| Coupling | | | | |
| Coefficient | | | | |
| (−25 mm~+25 | | | | |
| mm) | | | | |

Table 1 shows the standard deviation of the coupling coefficient K in a period of −25 mm to +25 mm based on the central portion of the transmission coil unit 130 of each of Examples and Comparative Examples in the graph shown in FIG. 8.

It can be appreciated from Table 1 that the standard deviation of the coupling coefficient K of the transmission coil unit 130 in the dumbbell shape according to the preferred embodiment of the present invention is smaller than the standard deviation of the coupling coefficient K according to Comparative Example.

The characteristics mean that the distribution of the wireless power transmission efficiency between the wireless charging apparatus and the receiver to be wireless charged is uniform. Even though the user puts the mobile phone or the smart phone in which the wireless receiving module is mounted at any position corresponding to the transmission coil unit 130 of the wireless charging apparatus 100, it is possible to obtain the wireless charging efficiency of a predetermined level or more.

As set forth above, the preferred embodiments of the present invention can provide the wireless charging apparatus including the transmission coil unit having the coil structure in which a turn loop is formed to have the dumbbell shape using the single coil so as to compensate for the non-uniform electromagnetic field distribution.

In addition, the preferred embodiments of the present invention can perform the transmission of wireless power by the transmission coil unit formed to have the single coil, thereby solving the problem of the complicated configuration including the driving circuits and the amplifiers corresponding to the number of coils according to the prior art.

Although the spirit of the present invention was described in detail with reference to the preferred embodiments, it should be understood that the preferred embodiments are provided to explain, but do not limit the spirit of the present invention.

Also, it is to be understood that various changes and modifications within the technical scope of the present invention are made by a person having ordinary skill in the art to which this invention pertains.

What is claimed is:

1. A coil structure for wireless charging, comprising:
a turn loop formed of a single coil, the turn loop having a major-axis side of which one side is longer than the other side, and
wherein at least one area of the major-axis side is formed in a form depressed inwardly.

2. The coil structure as set forth in claim 1, wherein the coil structure forms a flat loop in a form in which a depressed area d of the one area is formed inwardly by a step e.

3. The coil structure as set forth in claim 2, wherein the depressed area d is depressed inwardly by the step e in an arc form or an angled form.

4. The coil structure as set forth in claim 1, wherein the coil structure is formed in a dumbbell shape in which a middle portion of the major-axis side is depressed inwardly.

5. A wireless charging apparatus, comprising:
a control unit performing a general control of a wireless charging process;
a driving unit connected to the control unit to generate a wireless power signal to be transmitted according to the control of the control unit;
a transmission coil unit connected to the driving unit as a coil structure in a turn loop form formed of a single coil and transmitting wireless power according to the wireless power signal, the turn loop form having a major-axis side of which one side is longer than the other side and at least one area is formed in a form depressed inwardly; and
a sensing unit connected between the transmission coil unit and the control unit to detect whether the wireless charging receiver is positioned corresponding to the transmission coil unit and transfer the detected state to the control unit.

6. The wireless charging apparatus as set forth in claim 5, wherein the transmission coil unit forms a flat loop in a form in which a depressed area d of the one area is formed inwardly by a step e.

7. The wireless charging apparatus as set forth in claim 6, wherein the depressed area d is depressed inwardly by the step e in an arc form or an angled form.

8. The wireless charging apparatus as set forth in claim 5, wherein the driving unit includes a single driving circuit and amplifier for the transmission coil unit.

9. The wireless charging apparatus as set forth in claim 5, wherein the coil structure of the transmission coil unit forms a loop in a dumbbell shape in which a middle area of the major-axis side is depressed inwardly.

10. The wireless charging apparatus as set forth in claim 5, wherein as a coupling coefficient K regarding the transmission coil unit is large, a value of inductance L of the transmission coil unit required to transmit the wireless power is small and as the inductance L is small, the number of turn loops of the transmission coil unit is small.
